(19) United States
(12) Patent Application Publication
(10) Pub. No.: US 2023/0274467 A1
(43) Pub. Date: Aug. 31, 2023

(54) IMAGE ENCODING APPARATUS, IMAGE ENCODING METHOD AND PROGRAM

(71) Applicant: NIPPON TELEGRAPH AND TELEPHONE CORPORATION, Tokyo (JP)

(72) Inventors: Shiori SUGIMOTO, Musashino-shi, Tokyo (JP); Takayuki KUROZUMI, Musashino-shi, Tokyo (JP); Hideaki KIMATA, Musashino-shi, Tokyo (JP)

(73) Assignee: NIPPON TELEGRAPH AND TELEPHONE CORPORATION, Tokyo (JP)

(21) Appl. No.: 18/015,303

(22) PCT Filed: Jul. 13, 2020
(86) PCT No.: PCT/JP2020/027258

§ 371 Date: Jan. 9, 2023

(51) Int. Cl. G06T 9/00

(52) U.S. Cl. CPC G06T 9/002

(57) ABSTRACT

An image encoding method is an image encoding method executed by an image encoding device, the method including: a feature map generating step of generating a first feature map representing a feature of an encoding target image which is an encoding target image and a second feature map representing a feature of the encoding target image at different resolutions; a correlation map generation step of generating a correlation map representing a correlation distribution between the first and second feature maps; a contraction function generation step of generating a contraction function which is a function used for a contraction process for a predetermined image in a decoding process based on the correlation map; and an encoding step of executing an encoding process on the contraction function and outputting a result of the encoding process.

### TECHNICAL FIELD

The present invention relates to an image encoding method, an image encoding device, and a program.

### BACKGROUND ART

In compression encoding for an image, entropy encoding is executed after an orthogonal transform is executed from an image domain (spatial domain) to a frequency domain through discrete cosine transform (DCT), discrete sine transform (DST), or wavelet transform in some cases. In these cases, since dimensions of a basis of transformation are the same as dimensions of an image, an amount of information is not reduced before and after the transformation, but distribution of data is biased due to the transformation, thereby improving encoding efficiency by entropy encoding. In these cases, the amount of information can be further reduced by coarsely quantizing a high-frequency component having a low rate of contribution to subjective image quality.

In moving-image encoding, an image is divided into blocks which are units of processes in order to further improve a compression rate. An image signal of a subject is spatially and temporally predicted for each block using spatial and temporal continuity of an image, and thus the prediction residual signal is generated for each block. By encoding prediction information indicating a prediction method and a result of the transformation and quantization executed on the prediction residual signal, it is possible to considerably improve encoding efficiency, compared to a case where an image signal itself is encoded.

In JPEG which is a standard specification for still images, and “H.264/AVC” and “H.265/HEVC” which are standard specifications for moving-image encoding, an encoding amount to be generated is controlled by adjusting quantization parameters (QP) used when coefficients of DCT and DST are quantized. On the other hand, since a high-frequency component of an image is missing due to an increase in the quantization parameter, the image quality deteriorates. In addition, block distortion occurring at a boundary between blocks affects image quality.

In encoding in which fractal compression is used (hereinafter referred to as “fractal compression encoding”), an image is assumed to have self-similarity. That is, it is assumed that each partial region of an image can be approximated using a contraction result of the other partial regions. In the fractal compression encoding based on this assumption, a function used for a contraction process (hereinafter referred to as a “contraction function”) on a predetermined image (an initial image) in the decoding process is encoded instead of encoding an original image and a transformation coefficient (see Non Patent Literature 1).

In the decoding process for fractal compression encoding, an original image is decoded by repeatedly applying the contraction function to an arbitrary image. The decoding process is based on the collage theorem. The collage theorem is a theorem that, when a collage generated from a contracted image of an original image favorably approximates the original image, the contraction function is repeatedly applied to the collage similarly generated from an arbitrary image, so that the collage favorably approximates the original image.

In the fractal compression encoding, an image can be expressed with a very small encoding amount, compared to an encoding amount of image encoding based on prediction and transformation. In addition, the fractal compression encoding has a characteristic that a decoded image having an arbitrary resolution (scale) can be generated without deterioration.

In the fractal compression encoding, the contraction function is derived for each block into which an image to be encoded is divided (hereinafter referred to as an “encoding target image”). Affine transformation that has translation, rotation, and scaling as parameters is often used as a form of the contraction function. Here, a parameter of affine transformation is derived in some cases by executing matching (block matching) on each block between an image (a scaled image) of which a resolution is changed with respect to an encoding target image and the encoding target image.

A corresponding region that minimizes an error between pixels is derived by using a mean square error (MSE) as a cost function of the block matching. By executing sufficient searching, the contraction function is represented using simple affine transformation. However, since the number of possible combinations of parameters is considerable, calculation cost is significantly high.

As a matching method of deriving a correspondence relationship between partial regions of an image, there is feature point matching in methods other than the block matching. Examples of the feature point matching include scale-invariant feature transform (SIFT) and speeded up robust feature (SURF). For example, when an optical flow is detected or a 3-dimensional shape is estimated, feature point matching is used as a method of deriving corresponding points between two different images.

In the feature point matching, only characteristic points in each image are derived as a small number of key points. For each key point, a feature amount that is invariant with respect to rotation and a change in resolution (scaling change) of an image is generated based on a Gaussian pyramid. By comparing such feature amounts between key points, corresponding points between images are derived at a high speed.

By comparing the feature amounts of the key points detected in the same image, it is also possible to derive a correspondence relationship between partial regions in the same image. However, when it is necessary to derive portions corresponding to all blocks in the same image, it is necessary to compare a feature amount of each block with a feature amount of all the pixels. Therefore, the difference between the calculation required for feature point matching and the calculation amount necessary for block matching is not large.

Furthermore, as a method for deriving corresponding points between two different images, a deep neural network may be used. For example, in a method called FlowNetC (see Non Patent Literature 2), extraction of a feature map by a neural network that extracts features of an image is executed for each encoding target image, and a correlation map is generated based on two feature maps. An optical flow from one image between two different images to the other is derived using the neural network (a flow estimation network) to which the correlation map is input.

In this method, a translation parameter between pixels of two different images is derived at a high speed. However, this method is not a method of deriving a transform parameter involving a change in resolution and rotation for a region with a size like a transform parameter of affine transformation.

A distribution (map) of a correlation between the same feature maps always has a peak at a point at which a movement amount is 0. Therefore, values of all the flows output from a network that extracts the optical flows are 0. Therefore, a neural network that extracts an optical flow cannot be used to detect self-similarity.

### CITATION LIST

### Non Patent Literature

Non Patent Literature 1: A. E. Jacquin, “Image coding based on a fractal theory of iterated contractive image transformations,” IEEE Transactions on Image Processing, vol. 1, no. 1, pp. 18-30, January 1992.

Non Patent Literature 2: Philipp Fischer, et al., “FlowNet:Learning Optical Flow with Convolutional Networks,” arXiv:1504.06852v2 [cs.CV], 4 May 2015.

### SUMMARY OF INVENTION

### Technical Problem

In fractal compression encoding, an operation amount necessary for decoding is linear with respect to time. On the other hand, an operation amount necessary for encoding is greater than an operation amount necessary for decoding. The reason why the operation amount necessary for encoding is greater is that, when another partial region corresponding to a partial region in an image is searched for, the number of combinations of the parameters (position parameters, rotation parameters, and contraction rate parameters) of the contraction function is considerable. Therefore, a searching region and a rotation angle may be limited in some cases. In addition, a contraction ratio may be fixed in some cases. However, under such limitations, there are few cases where an encoding target image can be appropriately approximated, and it is difficult to achieve high-quality encoding by fractal compression encoding.

In an image encoding scheme other than the fractal compression encoding, a process of “rate-distortion optimization” optimization (hereinafter referred to as “RD optimization”) is executed in order to optimize a balance between an encoding amount and image quality. However, the RD optimization is difficult in the fractal compression encoding.

In general, in a prediction encoding process of an image encoding scheme other than fractal compression encoding, an encoding target image is decoded by referring to a partial region from another partial region. The quality of the decoded partial region affects decoding quality (image quality) of other partial regions that refer to the decoded partial region. Therefore, on the premise that the partial regions are sequentially decoded, only the already decoded partial regions can be referred to from the other partial regions. In the encoding process, a reference region is determined based on a decoded image. Therefore, it is possible to control the image quality of each partial region in consideration of a balance with the encoding amount.

In the fractal compression encoding, on the other hand, decoding is simultaneously executed on all partial regions in the encoding target image through an iteration process. Therefore, of all the partial regions, only some regions cannot be decoded first. Accordingly, when the RD optimization is executed, it is necessary to simultaneously determine the contraction function not for each partial region but for all the partial regions of the encoding target image.

As described above, the image quality cannot be improved after a calculation amount of the fractal compression encoding is suppressed in some cases.

In view of the foregoing circumstances, an objective of the present invention is to provide an image encoding method, an image encoding device, and a program capable of improving image quality after suppressing a calculation amount of fractal compression encoding.

### Solution to Problem

According to an aspect of the present invention, there is provided an image encoding method executed by an image encoding device. The method includes: a feature map generating step of generating a first feature map representing a feature of an encoding target image which is an encoding target image and a second feature map representing a feature of the encoding target image at different resolutions; a correlation map generation step of generating a correlation map representing a correlation distribution between the first and second feature maps; a contraction function generation step of generating a contraction function which is a function used for a contraction process for a predetermined image in a decoding process based on the correlation map; and an encoding step of executing an encoding process on the contraction function.

According to another aspect of the present invention, there is provided an image encoding device including: a feature map generation unit configured to generate a first feature map representing a feature of an encoding target image which is an encoding target image and a second feature map representing a feature of the encoding target image at different resolutions; a correlation map generation unit configured to generate a correlation map representing a correlation distribution between the first and second feature maps; a contraction function generation unit configured to generate a contraction function which is a function used for a contraction process for a predetermined image in a decoding process based on the correlation map; and an encoding unit configured to execute an encoding process on the contraction function.

According to still another aspect of the present invention, there is provided a program causing a computer to function as the image encoding device.

### Advantageous Effects of Invention

According to the present invention, it is possible to improve image quality after suppressing a calculation amount of the fractal compression encoding.

### BRIEF DESCRIPTION OF DRAWINGS

FIG. 1 is a diagram illustrating an example of a configuration of an image processing system.

FIG. 2 is a flowchart illustrating an example of an operation of an image encoding device.

FIG. 3 is a diagram illustrating an example of a hardware configuration of the image encoding device.

### DESCRIPTION OF EMBODIMENTS

An embodiment of the present invention will be described in detail with reference to the drawings.

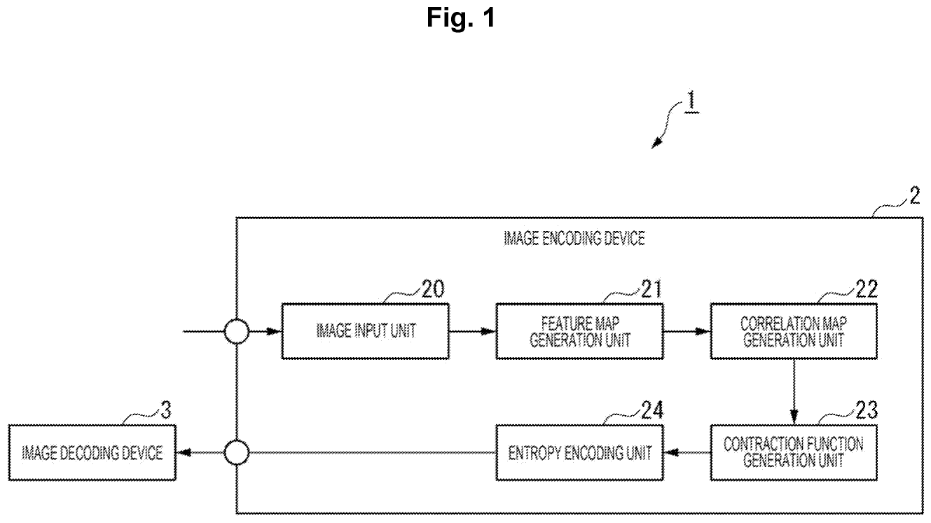

FIG. 1 is a diagram illustrating an example of a configuration of an image processing system 1. The image processing system 1 includes an image encoding device 2 and an image decoding device 3. The image encoding device 2 is a device that encodes an image. The image decoding device 3 is a device that decodes an image.

The image encoding device 2 includes an image input unit 20, a feature map generation unit 21, a correlation map generation unit 22, a contraction function generation unit 23, and an entropy encoding unit 24. The feature map generation unit 21 and the contraction function generation unit 23 include a neural network learned using a machine learning scheme. The image decoding device 3 may include a neural network and a dictionary used for the machine learning scheme.

Next, the image encoding device 2 will be described.

The image input unit 20 acquires an encoding target image as an input. The image input unit 20 outputs the encoding target image to the feature map generation unit 21.

Hereinafter, a first set of one or more feature maps representing features of an encoding target image is referred to as a “first feature map.” Hereinafter, a second set of one or more feature maps representing features of an encoding target image is referred to as a “second feature map.”

The feature map generation unit 21 generates the first and second feature maps based on the encoding target image. The feature map generation unit 21 outputs the first and second feature maps to the correlation map generation unit 22.

A scale of the first feature map is different from a scale of the second feature map. For example, one of the first and second feature maps is an equal scale (original resolution), and the other is a “½” scale.

The first feature map may include feature maps with a plurality of scales. Similarly, the second feature map may include feature maps with a plurality of scales. For example, one of the first and second feature maps may include a feature map with the equal scale and a feature map of a “½” scale, and the other may include a feature map of a “⅓” scale and a feature map of a “⅕” scale.

A method in which the feature map generation unit 21 generates the feature maps is not limited to a specific method. For example, the feature map generation unit 21 may execute various filtering processes on the encoding target image and may use, as feature maps, a set of samples obtained as results by executing a sampling process on the results of the filtering processes.

Here, sampling density of the second feature map may be set to a density coarser than sampling density of the first feature map. Under such settings, the sampling process is executed on the first and second feature maps independently. The feature map generation unit 21 may execute the sampling process on the first feature map and set a result obtained by executing the sampling process as the second feature map.

The feature map generation unit 21 includes, for example, one neural network. Here, the feature map generation unit 21 may generate the first feature map from the first intermediate layer of the neural network and generate the second feature map from the second intermediate layer of the neural network.

The feature map generation unit 21 may include a plurality of neural networks. For example, the feature map generation unit 21 may generate the first feature map using a first neural network and generate the second feature map using a second neural network.

The correlation map generation unit 22 generates a correlation map based on the first and second feature maps. The correlation map generation unit 22 outputs the correlation map to the contraction function generation unit 23. The method in which the correlation map generation unit 22 generates the correlation map is not limited to a specific method.

For example, the correlation map generation unit 22 may execute an operation using matrices of the first and second feature maps and use the executed result as a correlation map.

For example, the correlation map generation unit 22 may use an output of the neural network to which the first and second feature maps are input, as a correlation map.

For example, the correlation map generation unit 22 may set an inner product of a first feature map “F₁” and a second feature map “F₂” as a correlation map “C.” The correlation map “C” is expressed as in, for example, Expression (1).

$$[ Math . 1 ]$$

$$C ( {x}_{1} , {x}_{2} ) = {\sum }_{o ∈ [ - k , k ] \times [ - k , k ]} 〈 {F}_{1} ( {x}_{1} + o ) , {F}_{2} ( {x}_{2} + o ) 〉 \qquad ( 1 )$$

Here, “k” represents any patch size. When an encoding target image “I” is a second-order tensor of “w×h,” the first feature map “F₁” is a third-order tensor of “w′₁×h′₁×d,” and the second feature map “F₂” is a third-order tensor of “w′₂×h′₂×d,” the correlation map “C” is a fourth-order tensor of “w′₁×h′₁×w′₂×h′₂.”

When the correlation map “C” is an inner product of the first feature map “F₁” and the second feature map “F₂,” the number of feature maps included in the first feature map is equal to the number of feature maps included in the second feature map.

The contraction function generation unit 23 generates a contraction function based on the correlation map. The contraction function generation unit 23 outputs the correlation map to the entropy encoding unit 24. A method in which the contraction function generation unit 23 generates a contraction function is not limited to a specific generation method.

For example, the contraction function generation unit 23 estimates a positional deviation amount and a positional deviation direction of corresponding points between the correlation maps, a resolution (scale) of each correlation map, and a rotational deviation amount and a rotational direction of the corresponding points between the correlation maps based on positions of correlation peaks in the correlation maps. The contraction function generation unit 23 may generate a contraction function based on these estimation results.

For example, the contraction function generation unit 23 may generate the contraction function using a machine learning scheme in which a neural network or the like is used. The neural network outputs the contraction function (a parameter for defining the contraction function) by inputting the correlation maps.

The parameter for defining the contraction function is not limited to a specific parameter. For example, the parameter for defining the contraction function may be any of a matrix for affine transformation, a vector representing the position and rotation of a corresponding point, a parameter representing a sampling filter, and a parameter for correcting a change in luminance.

The contraction function generated based on the correlation map may be a set of a plurality of contraction functions (a contraction function system). For example, the contraction function generation unit 23 may divide the encoding target image into a plurality of blocks and generate a contraction function for each block. For example, the contraction function generation unit 23 may determine a representative point (a characteristic point) in the encoding target image and generate a contraction function for each partial region centering on the representative point.

The entropy encoding unit 24 executes entropy encoding on the contraction function. Here, the entropy encoding unit 24 may encode the contraction function and any additional information. For example, the additional information may be an initialization parameter or an optimization parameter used for decoding an image. The entropy encoding unit 24 outputs a result of the entropy encoding to the image decoding device 3. The entropy encoding unit 24 may record the result of the entropy encoding in a storage device.

Next, the image decoding device 3 will be described. The image decoding device 3 acquires the result of entropy encoding from the entropy encoding unit 24. The decoding process executed by the image decoding device 3 is not limited to a specific decoding process in the entropy encoding. For example, the image decoding device 3 executes the decoding process of the general fractal compression. That is, the image decoding device 3 generates a decoded contraction function (hereinafter referred to as a “decoding contraction function”) by executing entropy decoding on the contraction function subjected to the entropy encoding. The image decoding device 3 decodes the encoding target image by executing the decoding process on the encoding target image subjected to the entropy encoding using the decoding contraction function.

The image decoding device 3 transforms a predetermined image (initial image) into a first decoded image using the decoding contraction function for the initial image. The image decoding device 3 transforms the first decoded image into the second decoded image using the decoding contraction function for the first decoded image. By iterating the transformation, the image decoding device 3 generates a final decoded image.

Next, an example of a method in which the feature map generation unit 21 generates a feature map and an example of a method in which the contraction function generation unit 23 generates a contraction function will be described.

The feature map generation unit 21 and the contraction function generation unit 23 each include a neural network. The feature map generation unit 21 and the contraction function generation unit 23 execute a learning process so that Expression (2) is satisfied.

$$[ Math . 2 ]$$

$$M , F = {arg min}_{M , F} {\vert R ( F ( C ( M ( {I}_{org} ) ) ) , {I}_{0} ) - {I}_{org} \vert}_{2}^{2} \qquad ( 2 )$$

Here, “I_{org}” represents an encoding target image.

“M” represents the neural network of the feature map generation unit 21. “M(I_{org})” represents an output (feature map) of the neural network of the feature map generation unit 21. “C” represents a neural network of the correlation map generation unit 22. “C()” represents an output (correlation map) of the neural network of the correlation map generation unit 22. “F” represents the neural network of the contraction function generation unit 23. “F()” represents an output (contraction function system) of the neural network of the contraction function generation unit 23. “R” represents a decoder of the image decoding device 3. “R()” represents an output (final decoded image) of the decoder of the image decoding device 3. “I₀” represents a predetermined image (initial image).

That is, the feature map generation unit 21 and the contraction function generation unit 23 update the parameters of the neural network so that an error (for example, a square error) of the final decoded image “R()” with respect to the encoding target image “I_{org} is minimized.”

A regularization term may be added to Expression (2). An encoding amount of the parameter of the contraction function may be added as a loss to Expression (2).

The feature map generation unit 21 and the contraction function generation unit 23 may update the parameters of the neural networks using a predetermined image quality evaluation index, instead of using the square error. The feature map generation unit 21 and the contraction function generation unit 23 may update the parameters of the neural networks using another evaluation index used in a predetermined image generation problem. The feature map generation unit 21 and the contraction function generation unit 23 may update the parameters of the neural networks using, for example, an error of each feature amount in a low-dimensional (low-resolution) image.

For example, the feature map generation unit 21 and the contraction function generation unit 23 may simultaneously learn each neural network of the feature map generation unit 21 and the contraction function generation unit 23 and an image identification network as a generative adversarial network. Accordingly, the feature map generation unit 21 and the contraction function generation unit 23 can realize maximization of perceptual quality that cannot be realized in matching search of the related art.

The feature map generation unit 21 and the correlation map generation unit 22 may execute a learning process (preliminary learning) before an input of an encoding target, or may execute a learning process (relearning) for each input of an encoding target. For example, the feature map generation unit 21 and the correlation map generation unit 22 may execute the preliminary learning as in Expression (1) and execute relearning for adding a loss related to an encoding amount of the parameter to Expression (1) for each encoding target image. In this way, it is possible to realize RD optimization.

The feature map generation unit 21 and the contraction function generation unit 23 may simultaneously execute the learning process or execute the learning process at different times. For example, when the image decoding device 3 includes a neural network, the feature map generation unit 21, the contraction function generation unit 23, and the image decoding device 3 may simultaneously execute the learning process.

Next, an example of an operation of the image encoding device 2 will be described.

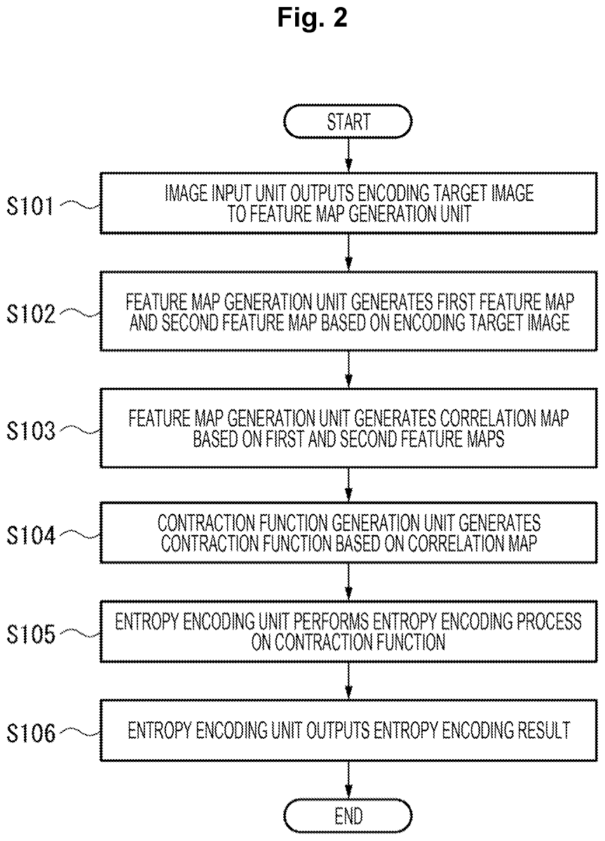

FIG. 2 is a flowchart illustrating an example of an operation of the image encoding device 2. The image input unit 20 outputs the encoding target image (step S101). The feature map generation unit 21 generates the first and second feature maps based on the encoding target image (step S102). The correlation map generation unit 22 generates the correlation map based on the first and second feature maps (step S103).

The contraction function generation unit 23 generates the contraction function based on the correlation map (step S104). The entropy encoding unit 24 (encoding unit) executes an encoding process on the contraction function (step S105). The entropy encoding unit 24 outputs an encoding result (step S106).

As described above, the feature map generation unit 21 generates the first and second feature maps with different resolutions. The correlation map generation unit 22 generates the correlation map representing a distribution of correlations between the first and second feature maps. The contraction function generation unit 23 generates a contraction function which is a function used for the contraction process for a predetermined image in the decoding process executed by the image decoding device 3 based on the correlation map. The entropy encoding unit 24 executes an encoding process on the contraction function.

As described above, the image encoding device 2 derives two feature maps that have different resolutions (scales) based on one encoding target image. The image encoding device 2 generates the correlation map between the two feature maps that have the different resolutions. In the correlation map between the two feature maps that have the different resolutions, the correlation does not have a peak at the point of the movement amount “0,” so that the correlation map can be used to detect self-similarity in the encoding target image. The image encoding device 2 generates a contraction function system based on the correlation map (the detection result of the self-similarity in the encoding target image).

Accordingly, it is possible to improve the image quality after suppressing the calculation amount of the fractal compression encoding. That is, it is possible to realize the fractal compression encoding with high efficiency and realize the RD optimization after suppressing the calculation amount necessary for encoding.

The contraction function generation unit 23 may estimate the positional deviation amount and the positional deviation direction of the corresponding point between the correlation maps, the resolution of each correlation map, and the rotational deviation amount and the rotational direction of the corresponding point between the correlation maps based on the position of the correlation peak in the correlation map. The contraction function generation unit 23 may generate a contraction function based on an estimation result. The contraction function generation unit 23 may include a neural network. The neural network of the contraction function generation unit 23 may generate the contraction function using the correlation map as an input.

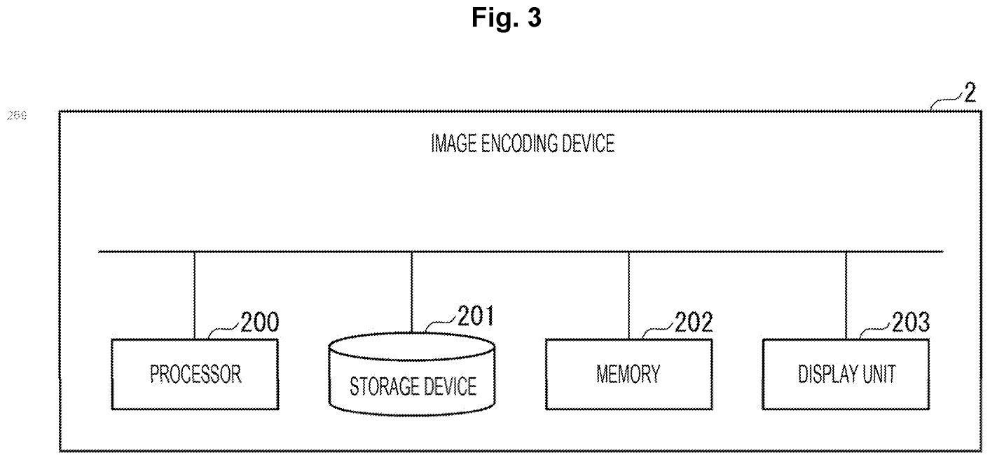

FIG. 3 is a diagram illustrating an example of a hardware configuration of the image encoding device 2. Some or all of the functional units of the image encoding device 2 are realized as software by causing a processor 200 such as a central processing unit (CPU) to execute a program stored in a storage device 201 including a nonvolatile recording medium (non-transitory recording medium) and a memory 202. The program may be recorded in a computer-readable recording medium. The computer-readable recording medium is, for example, a portable medium such as a flexible disk, a magneto-optical disk, a read-only memory (ROM), or a compact disc read-only memory (CD-ROM), or a non-transitory recording medium such as a storage device such as a hard disk built in a computer system. The display unit 203 displays the converted image.

Some or all of the functional units of the image encoding device 2 may be realized using hardware including an electronic circuit (electronic circuit or circuitry) in which, for example, a large scale integration (LSI), an application specific integrated circuit (ASIC), a programmable logic device (PLD), a field programmable gate array (FPGA), or the like is used.

Although the embodiments of the present invention have been described in detail with reference to the drawings, specific configurations are not limited to the embodiments, and include design and the like within the scope of the present invention without departing from the gist of the present invention.

### INDUSTRIAL APPLICABILITY

The present invention can be applied to a device that encodes an image.

### REFERENCE SIGNS LIST

1 Image processing system
2 Image encoding device
3 Image decoding device
20 Image input unit
21 Feature map generation unit
22 Correlation map generation unit
23 Contraction function generation unit
24 Entropy encoding unit
200 Processor
201 Storage device
202 Memory
203 Display unit

1. An image encoding method executed by an image encoding device, the method comprising:
a feature map generating step of generating a first feature map representing a feature of an encoding target image which is an encoding target image and a second feature map representing a feature of the encoding target image at different resolutions;
a correlation map generation step of generating a correlation map representing a correlation distribution between the first and second feature maps;
a contraction function generation step of generating a contraction function which is a function used for a contraction process for a predetermined image in a decoding process based on the correlation map; and
an encoding step of executing an encoding process on the contraction function.

2. The image encoding method according to claim 1, wherein, in the contraction function generation step, a positional deviation amount and a positional deviation direction of a corresponding point between the correlation maps, a resolution of each of the correlation maps, and a rotational deviation amount and a rotational direction of a corresponding point between the correlation maps are estimated based on a position of a correlation peak in the correlation map, and the contraction function is generated based on an estimation result.

3. The image encoding method according to claim 1,
wherein the image encoding device includes a neural network, and
in the contraction function generation step, the neural network generates the contraction function using the correlation map as an input.

4. Image encoding device comprising:
a processor; and
a storage medium having computer program instructions stored thereon, when executed by the processor, perform to:
generate a first feature map representing a feature of an encoding target image which is an encoding target image and a second feature map representing a feature of the encoding target image at different resolutions;
generate a correlation map representing a correlation distribution between the first and second feature maps;
generate a contraction function which is a function used for a contraction process for a predetermined image in a decoding process based on the correlation map; and
execute an encoding process on the contraction function.

5. A non-transitory computer-readable medium having computer-executable instructions that, upon execution of the instructions by a processor of a computer, cause the computer to function as as the image encoding device according to claim 4.
